(19) United States
(12) Patent Application Publication
(10) Pub. No.: US 2013/0293686 A1
(43) Pub. Date: Nov. 7, 2013

(54) 3D RECONSTRUCTION OF HUMAN SUBJECT USING A MOBILE DEVICE

(71) Applicants: Anthony T. Blow, San Diego, CA (US); James Y. Wilson, San Diego, CA (US); David G. Heil, San Diego, CA (US); Andrei Dumitrescu, San Diego, CA (US)

(72) Inventors: Anthony T. Blow, San Diego, CA (US); James Y. Wilson, San Diego, CA (US); David G. Heil, San Diego, CA (US); Andrei Dumitrescu, San Diego, CA (US)

(73) Assignee: QUALCOMM Incorporated, San Diego, CA (US)

(21) Appl. No.: 13/463,646

(22) Filed: May 3, 2012

(51) Int. Cl. H04N 13/02

(52) U.S. Cl. 348/50; 348/E13.074

(57) ABSTRACT

A mobile device generates a 3D reconstruction of a human subject by capturing a video frame sequence of the human subject. A pre-generated marker, which may be reticle or a 3D model of a humanoid, is displayed on the display while capturing the video frame sequence. The human subject is also displayed and the mobile device is held to cause the human subject to be displayed coincidently with the pre-generated marker. The video frame sequence that is captured while the mobile device is held to cause the human subject to be displayed coincidently with the pre-generated marker is used to generate a 3D reconstruction of the human subject, which may then be stored and transmitted to a remote server if desired. Sensors may be used to determine the pose of the mobile device with respect to the human subject, which may then be used to adjust the pre-generated marker appropriately.

### BACKGROUND

1. Background Field

Embodiments of the subject matter described herein are related generally to three-dimensional (3D) reconstruction of a human subject, and more particularly to 3D reconstruction using mobile devices.

2. Relevant Background

Creation of three-dimensional (3D) models from photographs or video is a highly complex process requiring specialized equipment or large amounts of computational resources. For example, conventional algorithms seek to reconstruct 3D images by creating a 3D point cloud and then reducing the cloud into a smaller set of polygons. The 3D point cloud approach to modeling is prone to errors if the object to be reconstructed moves or the camera position with respect to the model is unknown. Furthermore, models generated by this approach are comprised of so many polygons that they cannot be easily edited or animated.

Thus, generating 3D models using mobile devices, such as a smart phone, tablet computer, or similar devices, is problematic even when the subject is relatively still. Moreover, conventional approaches to 3D modeling are computationally expensive, which further limits the availability of such systems to mobile devices. Consequently, the audience for 3D modeling is generally limited to a small set of sophisticated users with dedicated modeling devices.

### SUMMARY

A mobile device generates a 3D reconstruction of a human subject by capturing a video frame sequence of the human subject. A pre-generated marker, which may be reticle or a 3D model of a humanoid, is displayed on the display while capturing the video frame sequence. The human subject is also displayed and the mobile device is held to cause the human subject to be displayed coincidently with the pre-generated marker. The video frame sequence that is captured while the mobile device is held to cause the human subject to be displayed coincidently with the pre-generated marker is used to generate a 3D reconstruction of the human subject, in real-time, while the camera moves with respect to the human subject. The model may then be stored and transmitted to a remote server if desired. Sensors may be used to determine the pose of the mobile device with respect to the human subject, which may then be used to automatically adjust the pre-generated marker appropriately. The resulting 3D model is suitable for editing and animation, unlike other methods of 3D reconstruction which produce models of high complexity suitable only for visual inspection by rotation and zooming.

In one embodiment, a method includes capturing a video frame sequence of a human subject with a camera on a mobile device while at least one of the mobile device and the human subject is moved with respect to the other; displaying a pre-generated marker on a display of the mobile device while capturing the video frame sequence; displaying the human subject on the display while capturing the video frame sequence, wherein the mobile device is held to cause the human subject to be displayed coincidently with the pre-generated marker; using the video frame sequence captured while the mobile device is held to cause the human subject to be displayed coincidently with the pre-generated marker to generate a 3D reconstruction of the human subject; and storing the 3D model of the human subject.

In one embodiment, an apparatus includes a camera capable of capturing a video frame sequence of a human subject while at least one of the camera and the human subject is moved with respect to the other; a display capable of displaying the human subject while capturing the video frame sequence; memory; and a processor coupled to receive the video frame sequence from the camera and couple to the display and to the memory, the processor configured to display a pre-generated marker on the display while capturing the video frame sequence, to use the video frame sequence of the human subject captured while the camera is held to cause the human subject to be displayed coincidently with the pre-generated marker to generate a 3D reconstruction of the human subject; and to store the 3D model of the human subject in the memory.

In one embodiment, an apparatus includes means for capturing a video frame sequence of a human subject on a mobile device while at least one of the mobile device and the human subject is moved with respect to the other; means for displaying a pre-generated marker on a display of the mobile device while capturing the video frame sequence, wherein the human subject is displayed on the display while capturing the video frame sequence while the mobile device is held to cause the human subject to be displayed coincidently with the pre-generated marker; means for using the video frame sequence captured while the mobile device is held to cause the human subject to be displayed coincidently with the pre-generated marker to generate a 3D reconstruction of the human subject; and means for storing the 3D model of the human subject.

In one embodiment, a non-transitory computer-readable medium including program code stored thereon, includes program code to display a pre-generated marker on a display while capturing a video frame sequence of a human subject with a camera while at least one of the camera and the human subject is moved with respect to the other and the camera is held to cause the human subject to be displayed coincidently with the pre-generated marker; program code to use the video frame sequence captured while the camera is held to cause the human subject to be displayed coincidently with the pre-generated marker to generate a 3D reconstruction of the human subject; and program code to store the 3D model of the human subject.

### BRIEF DESCRIPTION OF THE DRAWING

FIG. 1 illustrates a mobile device displaying a human subject and a pre-generated marker and that is capable of efficiently producing a 3D reconstruction of a human subject.

FIGS. 2A and 2B illustrate examples of a pre-generated marker in the form of reticles.

FIG. 3 is a flow chart illustrating the method of generating a 3D reconstruction of a human subject.

FIG. 4 illustrates a process of generating a 3D reconstruction.

FIGS. 5A, 5B, and 5C illustrate the mobile device moved to different positions with respect to the human subject to capture images of the human subject from different perspectives.

FIGS. 6A, 6B, and 6C illustrate the display of the mobile device with the human subject overlapping a pre-generated 3D model for the respective positions shown in FIGS. 5A, 5B, and 5C.

FIG. 7 illustrates the display with the human subject and overlapping pre-generated 3D model with areas of completion of the 3D reconstruction indicated by the pre-generated 3D model.

FIG. 8 illustrates a deformable mesh pre-generated 3D model deforming to the human subject as the video frames are processed.

FIG. 9 illustrates an image of the 3D reconstruction that may be displayed on the display of the mobile device.

FIG. 10 illustrates the mobile device connected to a remote server through a wireless network.

FIG. 11 is a block diagram of a mobile device capable of producing a 3D reconstruction of a human subject.

### DETAILED DESCRIPTION

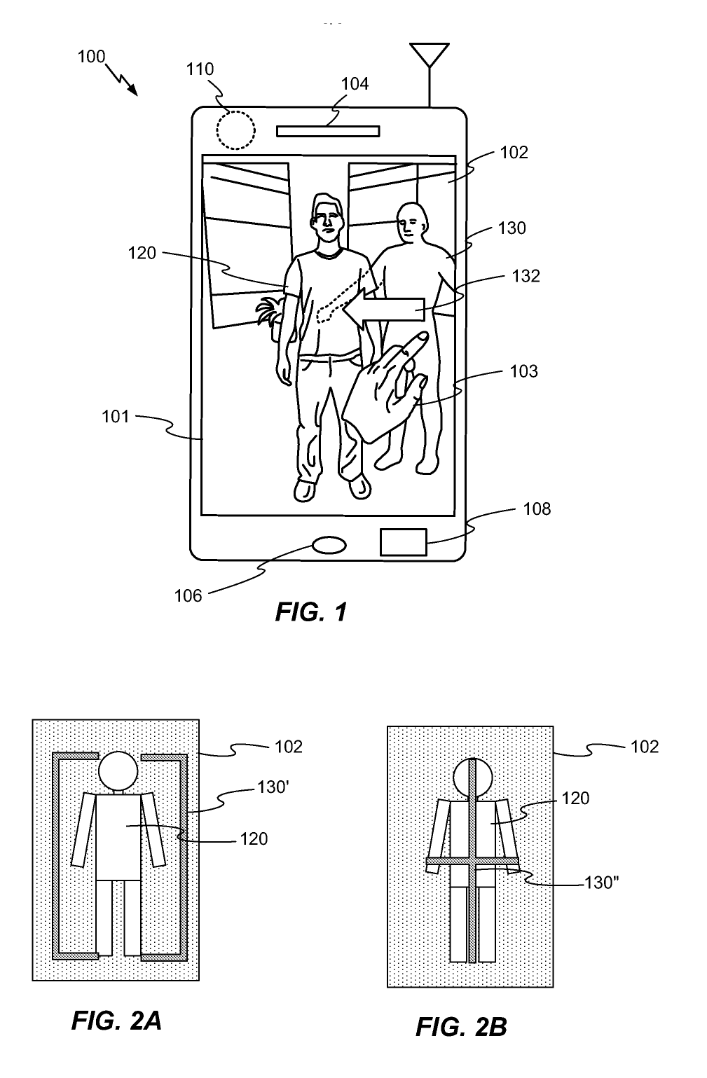

FIG. 1 illustrates mobile device 100 capable of efficiently producing a 3D reconstruction of a human subject. The mobile device 100 is illustrated as including a housing 101, a display 102, which may be a touch screen display, as well as a speaker 104 and microphone 106. The mobile device 100 further includes a camera 110 on the back side of the mobile device 100 to image a human subject 120 to be 3D reconstructed. The mobile device 100 further includes sensors 108, which may be one or more of accelerometers, magnetometers, and/or gyroscopes.

As used herein, a mobile device refers to any portable electronic device such as a cellular or other wireless communication device, personal communication system (PCS) device, personal navigation device (PND), Personal Information Manager (PIM), Personal Digital Assistant (PDA), laptop or other suitable mobile device. The mobile device may be capable of receiving wireless communication and/or navigation signals, such as navigation positioning signals. The term “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile device” is intended to include all electronic devices, including wireless communication devices, computers, laptops, tablet computers, smart phones etc. which are capable of imaging a subject to be modeled and generating a 3D reconstruction of the subject.

The sensors 108 in the mobile device 100 are used to track the position and orientation (pose) of the mobile device 100 (or more specifically, the camera 110) with respect to the human subject 120 while images of the human subject 120 are captured. The position information from sensors 108 may then be provided to assist in the 3D reconstruction of the human subject 120, in conjunction with a pre-generated marker. Thus, the mobile device 100 separately tracks the pose of the mobile device 100 with respect to the human subject 120, which may then be used to assist in the 3D reconstruction of the human subject 120, whereas conventional reconstruction techniques typically attempt to estimate the camera pose using features from captured images of the subject.

As illustrated in FIG. 1, a pre-generated marker 130 is displayed on the display 102 and may be used to assist in the 3D reconstruction of the human subject 120. The pre-generated marker 130 may be a 3D model, e.g., of a humanoid object as illustrated in FIG. 1. The relative depths of vertices in the 3D model may be used with the position information from sensor 108 to generate the 3D reconstruction of the human subject 120. If desired, other types of pre-generated markers 130 may be used. For example, as illustrated in FIGS. 2A and 2B, the human subject 120 may be displayed on the display 102 along with a pre-generated marker in the form of a reticle, which may be, e.g., brackets 130′ or cross-hairs 130″, respectively, or other desired shapes. The use of a pre-generated maker 130 in the form of a 3D model of a comparable bipedal-humanoid object, as illustrated in FIG. 1, may be particularly advantageous, as the 3D model may be capable of deforming in real-time to match the human subject 120 in the video stream of images captured by the camera 110 and/or indicate completed areas of the 3D reconstruction, and thus, pre-generated marker 130 may sometimes be referred to herein as a pre-generated 3D model 130. While generating a video frame sequence of the human subject 120 with the camera 110, the user may hold the mobile device 100 so that the human subject 120 is coincident with the pre-generated marker 130 displayed in the display 102, as illustrated in FIGS. 1, 2A, and 2C. If desired, the user may manipulate the pre-generated marker 130 within the display 102, e.g., by moving, adjusting, resizing, etc. the pre-generated marker 130, as illustrated by the user's hand 103 and the arrow 132 so that the pre-generated marker approximately matches the human subject 120, i.e., is coincident with the human subject 120 and has approximately the same size and orientation as the human subject 120. At the beginning of the modeling process, the pre-generated marker 130 may be positioned over the human subject 120 by touching the center of the displayed pre-generated marker 130 and dragging until positioned over the human subject 120. Additionally, where the pre-generated marker 130 is a 3D model of a humanoid, as illustrated in FIG. 1, the limbs of the pre-generated 3D model 130 may be moved similarly, e.g., by touching and dragging each limb to be positioned over the limbs of the human subject 120. Resizing the pre-generated marker 130 may be accomplished, e.g., by touching the display of the pre-generated marker 130 at two places and moving together to decrease the size and away to increase the size of the pre-generated marker 130. Rotation of the pre-generated marker 130, particularly, where the pre-generated marker 130 is a 3D model 130 of a humanoid, may be accomplished, if necessary, e.g., by touching the display at the head of the pre-generated 3D model 130 and moving the finger to the left or right on the display to rotate the pre-generated 3D model 130 to the left and right, respectively. Of course, other methods of adjusting the position, size and orientation of the pre-generated marker 130 may be used; including other touch screen techniques or using keypads or other user input devices if a touch screen display is not available.

As the mobile device 100 is moved with respect to the human subject 120 (or vice-versa), the pre-generated marker automatically maintains the coincident relationship between the displayed human subject 120 and the pre-generated marker 130. In other words, while the user moves the mobile device 100 to capture video of the human subject 120 from different perspectives, i.e., the sides and back, the user holds the mobile device 100 so that the human subject 120 continues to be coincident with the pre-generated marker 130 in the display 102. The size and orientation of the displayed pre-generated marker 130 may change as the mobile device 100 is moved around the human subject 120 based on data provided by the position and orientation sensors 108 in the mobile device 100. Thus, when the pre-generated marker 130 is a 3D model of a humanoid, or other 3D shape, the marker 130 may be displayed at approximately the same perspective as the human subject 120 while the mobile device 100 is moved. In addition, the pre-generated marker 130 may be, e.g., a deformable model or mesh, which may automatically deform to the human subject 120 as data from the human subject 120 is received and processed by the 3D reconstruction unit 112, particularly when the pre-generated marker 130 is a 3D model of a humanoid.

The use of pose tracking and the pre-generated marker leads to greatly reduced requirements for hardware and computational resources. With a large reduction in the hardware and computational resources it is possible to generate a 3D reconstruction of a human subject directly on the mobile device used to capture the video, which may be, e.g., a smart phone. Thus, the use of pose tracking and/or the pre-generated marker permits a much larger audience to access 3D reconstruction technology than is possible using existing technology.

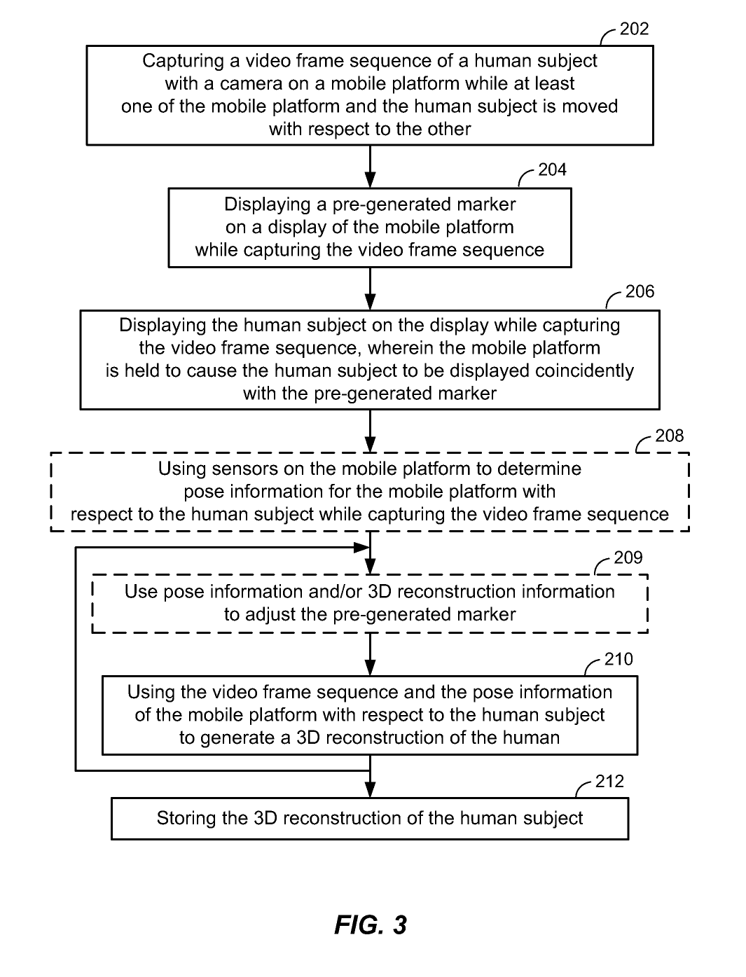

FIG. 3 is a flow chart illustrating the method of generating a 3D reconstruction of a human subject. As illustrated, a video frame sequence of a human subject is captured with a camera on a mobile device while at least one of the mobile device and the human is moved with respect to the other (202). The pre-generated marker is displayed on a display of the mobile device while capturing the video frame sequence (204). The pre-generated marker may be a 3D model of a humanoid or other 3D object. The human subject is displayed on the display while capturing the video frame sequence, wherein the mobile device is held to cause the human subject to be displayed coincidently with the pre-generated marker (206), which is gradually deformed to match the appearance of the humanoid subject. As illustrated by box 208, if desired motion and/or orientation sensors on the mobile device may be used to determine pose information for the mobile device with respect to the human subject while capturing the video frame sequence (208). The video frame sequence and the pose information of the mobile device with respect to the human subject are used to generate a 3D reconstruction of the human subject (210) and the resulting 3D reconstruction is stored (212). If desired, the pose information from block 208 (if used) and/or the 3D reconstruction information may be used to adjust the pre-generated marker that is displayed (209). For example, the pose information from block 208 may be used to appropriately change the position, size, and/or orientation of the pre-generated marker as the pose of the mobile device with respect to the human subject is changed. Moreover, information from the pre-generated marker, such as relative depths of vertices in a 3D model that serves as the pre-generated marker, may be used to assist in the 3D reconstruction of the human subject. Additionally, the 3D reconstruction information may be used to alter the texture, color, or otherwise alter the pre-generated marker to indicate areas of completion and areas that require additional image information.

Thus, the pre-generated 3D model may begin as an undifferentiated humanoid solid model, with a number of polygons reduced from that of the final model. This model may be initially positioned by the user over the location of a static (non-moving) human subject in the field of view of the camera. When model acquisition is triggered, the pre-generated 3D model automatically resizes and snaps into position over the human subject, and tracks with the movement of the static human subject as the camera is moved, e.g., based on pose information derived from sensors 108.

During the model acquisition, the pre-generated model is internally maintained as a “Control Mesh” that is iteratively modified as vertex updates are calculated. New vertices are added to the model so that the simplicity and coherence of the model is maintained, while progressively deforming the model surfaces to more closely match the appearance of the human subject. Existing vertices are repositioned when statistical calculations determine that the likelihood of the accuracy of the new position exceeds that of the old position.

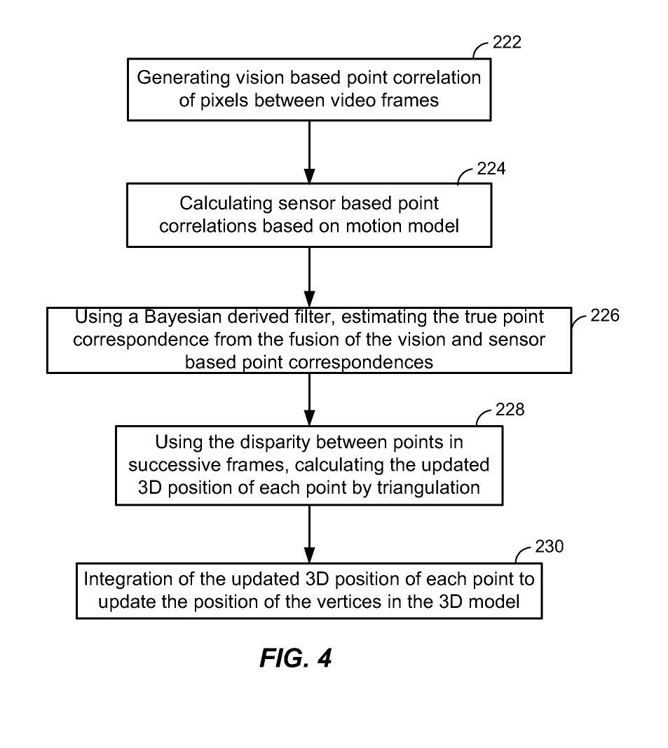

FIG. 4 illustrates a process of generating a 3D reconstruction (210). As illustrated, generate vision based point correlation of pixels between video frames (222). Sensor based point correlations are calculated using motion sensor information to generate a physical motion model (224). A Bayesian derived filter is used to estimate the true point correspondence from the fusion of the vision and sensor based point correspondences (226). The disparity between points in successive frames is used to calculate the updated 3D position of each point, e.g., by triangulation (228). The updated 3D position of each point is integrated with the 3D model to update the position of the vertices in the 3D model (230).

Thus, using the physical motion model generated in block 224, the pre-generated model tracks with the position of the human subject in the camera's field of view. As the Control Mesh is modified to more accurately represent the appearance of the human subject, the pre-generated model is also updated. This allows the pre-generated model to assume the form of the human subject in real-time while the camera is moved. The Control Mesh may be comprised of a series of interconnected polygons. Each vertex in the polygon is mapped to a 3D location on the surface of the human subject relative to the camera. Every n frames, the 3D position of each vertex is updated as indicated by the camera's motion sensors and point correspondence calculations between video frames. The repositioned vertexes are then re-rendered to form a Control Mesh in a new position matching that of the human subject. Thus, the Control Mesh is re-rendered and displayed in real-time to appear to rotate and translate with the position of the human subject in the field of view of the display.

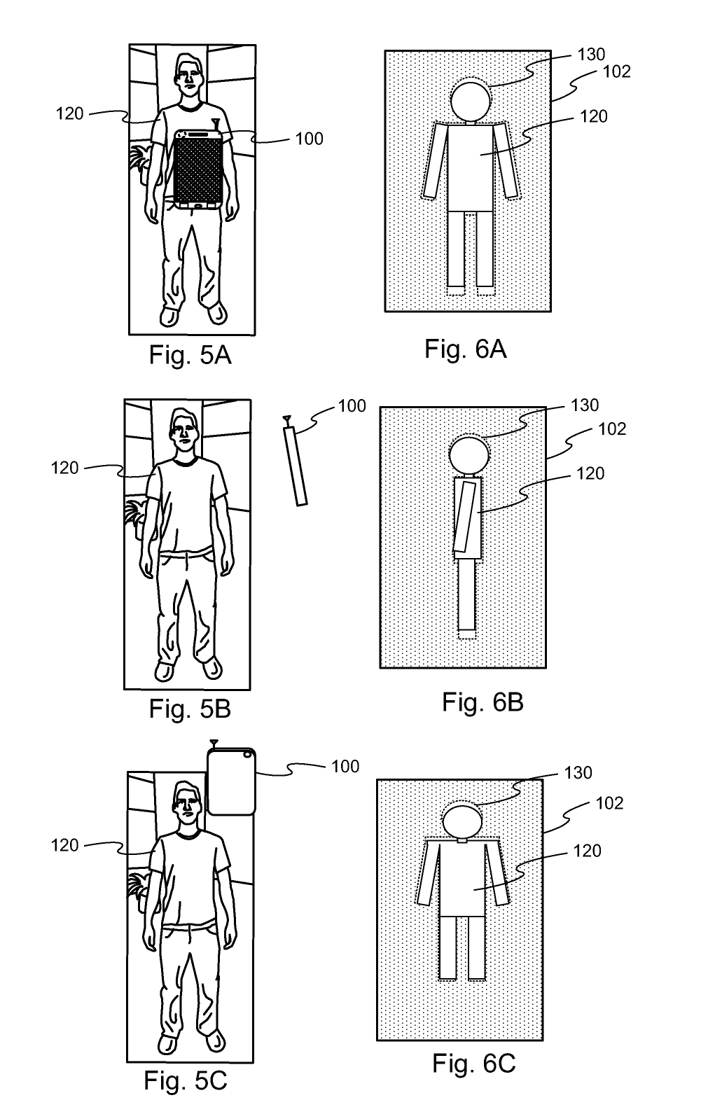

FIGS. 5A, 5B, and 5C, by way of example, illustrate the mobile device 100 moved to different positions with respect to the human subject 120 to capture images of the human subject from different perspectives. FIGS. 6A, 6B, and 6C illustrate the display 102 of the mobile device 100 with the human subject 120 overlapping the pre-generated 3D model 130 (shown with dotted line), for the respective positions shown in FIGS. 5A, 5B, and 5C. Thus, the user may move around the human subject 120 capturing video of the human subject 120 from every desired perspective, while maintaining the coincident relationship of the human subject 120 with the pre-generated 3D model 130. As illustrated in FIGS. 6A, 6B, and 6C, the orientation of the pre-generated 3D model 130 is automatically adjusted based on the motion of the mobile device 100 as determined from the data produced by sensors 108. The video of the human subject 120 from the video stream are used to produce the 3D reconstruction.

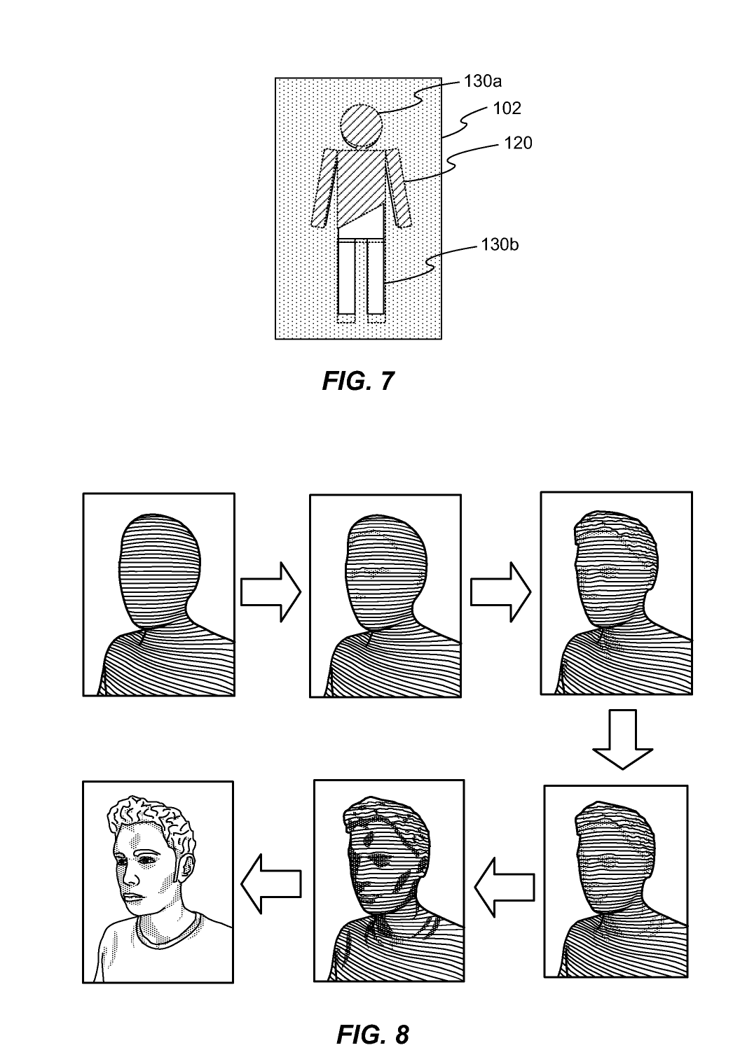

The pre-generated 3D model 130 may provide information to the user about which regions of the human subject 120 have been mapped by the 3D reconstruction unit 112 and which regions need additional image information to generate the 3D reconstruction. For example, FIG. 7 illustrates the display 102 with the human subject 120 and overlapping pre-generated 3D model 130. A portion 130a of the pre-generated 3D model 130 is illustrated as filled in (with stripes in the example of FIG. 7), indicating that the 3D reconstruction of the human subject 120 is completed for this portion 130a and no additional imaging is necessary for portion 130a. Portion 130b of the pre-generated 3D model 130, on the other hand, is not filled in thereby indicating to the user that additional imaging of this portion of the human subject 120 is necessary for the 3D reconstruction. Thus, as the user images the human subject 120 from different perspectives, the pre-generated 3D model 130 may fill in or otherwise indicate when enough information has been obtained for the 3D reconstruction.

FIG. 8 illustrates a deformable mesh pre-generated 3D model 130 deforming to the human subject 120 as the video frames are processed. The deformation of the pre-generated 3D model 130 may be performed in real time based on vertex updates as described above.

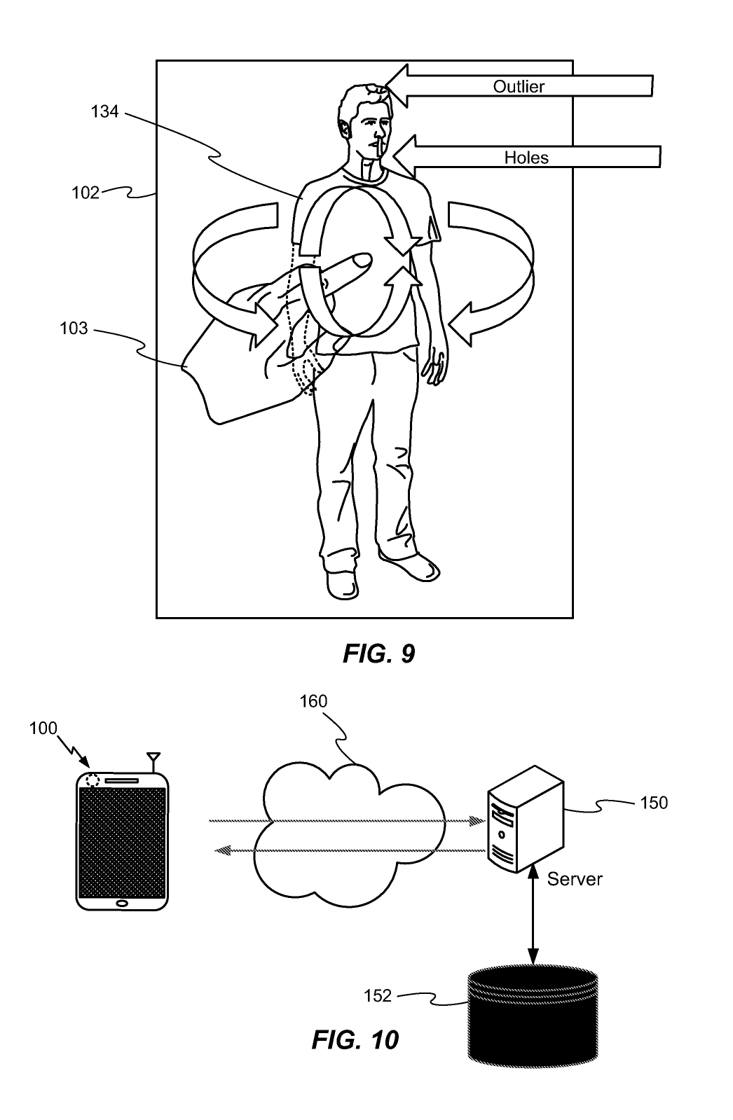

FIG. 9 illustrates an image of the 3D reconstruction 134 that may be displayed on the display 102 of the mobile device 100. The display of the 3D reconstruction 134 makes real-time modifications by the user possible, e.g., by capturing additional images of missing areas of the human subject, illustrated in FIG. 9 as holes, or by selecting and removing areas in the 3D reconstruction 134 that are not part of the human subject 120, illustrated in FIG. 9 as outlier. The user 103 may manipulate the orientation of 3D reconstruction of the human subject in the display 102 of the mobile device 100, e.g., using the touch screen display 102 to rotate the 3D reconstruction, in order to locate additional holes and outliers. Once a defect is found, the user may resume model acquisition, causing the pre-generated 3D model to automatically realign with the position of the human subject. Additional video of the hole or outlier is then obtained, and the correction then appears in the pre-generated 3D model.

Additionally, a centralized location for the user to store and share 3D reconstructions with application provides and other users, if desired, may be provided. The use of a centralized location to store and share 3D reconstructions is advantageous as it enables consumers to publish and share content as users begin to author their own 3D reconstructions. FIG. 10, by way of example, illustrates the mobile device 100 connected to a remote server 150 through a wireless network 160. Thus, the mobile device 100 may include a wireless interface 170 for transmitting and receiving wireless signals from network 160. The wireless interface 170 may use various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. Moreover, any combination of WWAN, WLAN and/or WPAN may be used.

The mobile device 100 may provide the generated 3D reconstruction to the server 150 through the network 160. The server 150 may include a database 152, which stores the 3D reconstruction along with other 3D reconstructions. The server 150 may also be used to transform the 3D reconstruction data into various formats including 3D models, 2D renderings, Flash, and animated images. By providing an intermediary server that is capable of managing and transforming 3D reconstruction data into a variety of formats, the content may be shared between content creators and content consumers. Content creators may control who may access the data and content consumers may receive the data preformatted in a form most useful to them (e.g., 3D models, 2D renderings, Flash, and animated images).

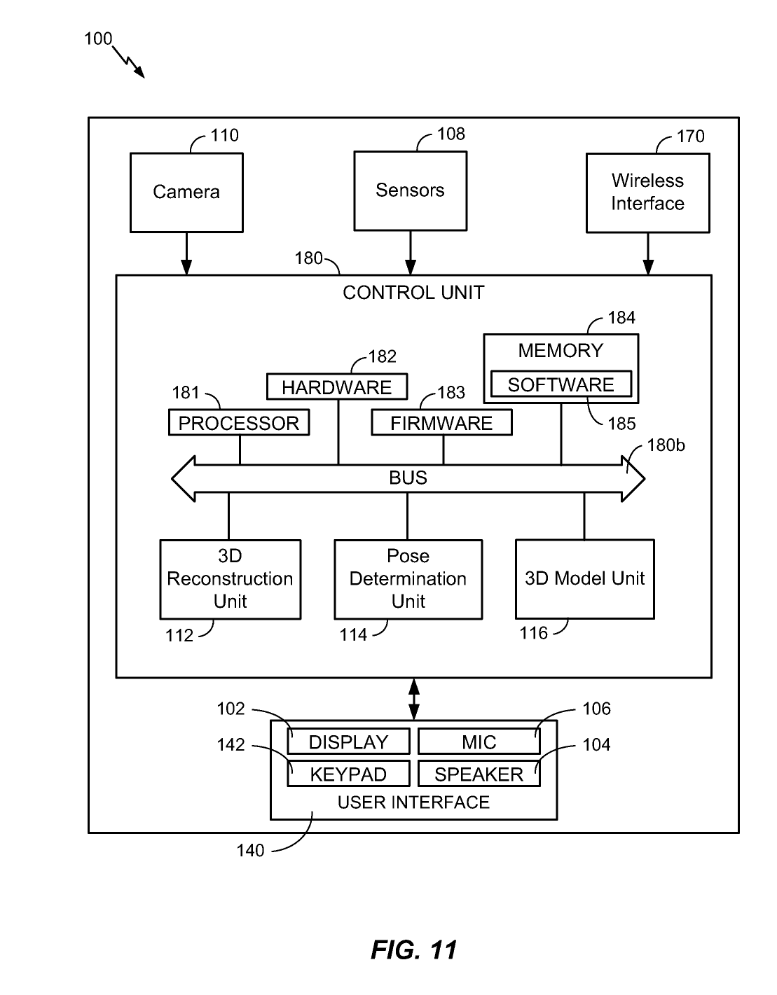

FIG. 11 is a block diagram of a mobile device 100 capable of producing a 3D reconstruction of a human subject as discussed above. The mobile device 100 includes a camera 110 and sensors 108, such as accelerometers, magnetometers, and/or gyroscopes. The mobile device 100 may further include a wireless interface 170 for transmitting and receiving wireless signals to a remote server 150 via the network 160 (FIG. 10).

The mobile device 100 may further includes a user interface 140 that includes the display 102, a keypad 105 142 other input device through which the user can input information into the mobile device 100, if the display 102 is not a touch screen display that includes a virtual keypad. The user interface 140 may also include a microphone 106 and speaker 104, e.g., if the mobile device 100 is a mobile device such as a cellular telephone. Of course, mobile device 100 may include other elements unrelated to the present disclosure.

The mobile device 100 also includes a control unit 180 that is connected to and communicates with the camera 110, sensors 108, and the wireless interface 170. The control unit 180 may be provided by a bus 180b, processor 181 and associated memory 184, hardware 182, software 185, and firmware 183. The control unit 180 includes the 3D reconstruction unit 112 as discussed above. The control unit 180 further includes a pose determination unit 114 that receives data from the sensors 108 and determines changes in the pose of the mobile device 100 with respect to the human subject 120. The control unit 180 further includes a 3D model unit 116, which provides the pre-generated 3D model, and adjusts displayed position, size, and orientation of the 3D model unit 116 based on data input from the user interface 140, as well as the pose determination unit 114 and 3D reconstruction unit 112.

The 3D reconstruction unit 112, pose determination unit 114, and 3D model unit 116 are illustrated separately and separate from processor 181 for clarity, but may be a single unit, combined units and/or implemented in the processor 181 based on instructions in the software 185 which is run in the processor 181. It will be understood as used herein that the processor 181, as well as one or more of the 3D reconstruction unit 112, pose determination unit 114, and 3D model unit 116 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile device, and is not to be limited to any particular type of memory or number of memories, or type of media upon which memory is stored.

The mobile device includes means for capturing a video frame sequence of a human subject on a mobile device while at least one of the mobile device and the human subject is moved with respect to the other, which may be, e.g., the camera 110. The mobile device further includes means for displaying a pre-generated marker on a display of the mobile device while capturing the video frame sequence, which may include, e.g., the 3D model unit 116 and the display 102. A means for using the video frame sequence captured while the mobile device is held to cause the human subject to be displayed coincidently with the pre-generated marker to generate a 3D reconstruction of the human subject may include, e.g., the 3D reconstruction unit 112. A means for storing the 3D model of the human subject may include, e.g., the memory 184. A means for deforming the pre-generated 3D model of the humanoid object to a shape of the human subject while capturing the video frame sequence may include the 3D model unit 116. Means for adjusting at least one of a position and size of the pre-generated marker in the display to be coincident with the display of the human subject based on user input may include the 3D model unit 116, as well as the display 102 and/or keypad 142. Means for using sensors to determine pose information for the mobile device with respect to the human subject while capturing the video frame sequence may include sensors 108 as well as pose determination unit 114. Means for adjusting at least one of a position and size of the pre-generated marker in the display based on the pose information while the video frame sequence is captured may include the 3D model unit 116. Means for transmitting the 3D reconstruction of the human subject to a remote server may include, e.g., the processor 181 and the wireless interface 170.

The methodologies described herein may be implemented by various means depending upon the application. For example, these methodologies may be implemented in hardware 182, firmware 163, software 185, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 184 and executed by the processor 181. Memory may be implemented within or external to the processor 181. If implemented in firmware and/or software, the functions may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
capturing a video frame sequence of a human subject with a camera on a mobile device while at least one of the mobile device and the human subject is moved with respect to the other;
displaying a pre-generated marker on a display of the mobile device while capturing the video frame sequence;
displaying the human subject on the display while capturing the video frame sequence, wherein the mobile device is held to cause the human subject to be displayed coincidently with the pre-generated marker;
using the video frame sequence captured while the mobile device is held to cause the human subject to be displayed coincidently with the pre-generated marker to generate a three-dimensional (3D) reconstruction of the human subject; and
storing the 3D reconstruction of the human subject.

2. The method of claim 1, wherein the pre-generated marker is a reticle.

3. The method of claim 1, wherein the pre-generated marker is a 3D model.

4. The method of claim 3, wherein the pre-generated 3D model is of a humanoid object.

5. The method of claim 4, wherein the 3D reconstruction is generated by updating vertices on the pre-generated 3D model of the humanoid object using the video frame sequence and the 3D reconstruction is displayed on the display.

6. The method of claim 5, further comprising rotating the 3D reconstruction to identify holes and outliers in the 3D reconstruction.

7. The method of claim 4, wherein the pre-generated 3D model of the humanoid object is a control mesh.

8. The method of claim 4, wherein the pre-generated 3D model of the humanoid object deforms to a shape of the human subject while capturing the video frame sequence.

9. The method of claim 1, further comprising adjusting at least one of a position and size of the pre-generated marker in the display to be coincident with the display of the human subject.

10. The method of claim 1, further comprising:
using sensors on the mobile device to determine pose information for the mobile device with respect to the human subject while capturing the video frame sequence; and
adjusting at least one of a position and size of the pre-generated marker in the display based on the pose information while capturing the video frame sequence.

11. The method of claim 10, further comprising using the pose information of the mobile device with respect to the human subject to generate the 3D reconstruction of the human subject.

12. The method of claim 10, wherein the sensors comprise at least one of accelerometers, gyroscopes, and magnetometers.

13. The method of claim 1, further comprising transmitting the 3D reconstruction of the human subject to a remote server.

14. The method of claim 13, further comprising receiving from the remote server at least one of a modified 3D model, a two-dimensional rendering, flash and animated images of the human subject based on the 3D reconstruction.

15. The method of claim 1, wherein using the video frame sequence captured while the mobile device is held to cause the human subject to be displayed coincidently with the pre-generated marker to generate the 3D reconstruction of the human subject comprises:
transmitting the video frame sequence to remote server; and
receiving the 3D reconstruction of the human subject from the remote server.

16. An apparatus comprising:
a camera capable of capturing a video frame sequence of a human subject while at least one of the camera and the human subject is moved with respect to the other;
a display capable of displaying the human subject while capturing the video frame sequence;
memory; and
a processor coupled to receive the video frame sequence from the camera and couple to the display and to the memory, the processor configured to display a pre-generated marker on the display while capturing the video frame sequence, to use the video frame sequence of the human subject captured while the camera is held to cause the human subject to be displayed coincidently with the pre-generated marker to generate a three-dimensional (3D) reconstruction of the human subject; and to store the 3D reconstruction of the human subject in the memory.

17. The apparatus of claim 16, wherein the pre-generated marker is one of a reticle and a 3D model.

18. The apparatus of claim 16, wherein the pre-generated marker is a pre-generated 3D model of a humanoid object.

19. The apparatus of claim 18, wherein the processor is configured to generate the 3D reconstruction by being configur3ed to update vertices on the pre-generated 3D model of the humanoid object using the video frame sequence and wherein the processor is configured to display the 3D reconstruction on the display.

20. The apparatus of claim 19, wherein the processor is further configured to rotate the 3D reconstruction to identify holes and outliers in the 3D reconstruction.

21. The apparatus of claim 18, wherein the pre-generated 3D model of the humanoid object is a control mesh.

22. The apparatus of claim 18, wherein the processor is configured to deform the pre-generated 3D model of the humanoid object to a shape of the human subject while the video frame sequence is captured.

23. The apparatus of claim 16, wherein the processor is configured to adjust at least one a position and size of the pre-generated marker in the display to be coincident with the display of the human subject in response to user input.

24. The apparatus of claim 16, further comprising sensors for receiving at least one of position and orientation data, wherein the processor is coupled to receive the at least one of position and orientation data, and is configured to determine pose information for the camera with respect to the human subject while capturing the video frame sequence, and to adjust at least one of a position and size of the pre-generated marker in the display based on the pose information while the video frame sequence is captured.

25. The apparatus of claim 24, wherein the processor is further configured to use the pose information of the camera with respect to the human subject to generate the 3D reconstruction of the human subject.

26. The apparatus of claim 24, wherein the sensors comprise at least one of accelerometers, gyroscopes, and magnetometers.

27. The apparatus of claim 16, further comprising a wireless interface coupled to the processor and configured to transmit the 3D reconstruction of the human subject to a remote server.

28. The apparatus of claim 27, wherein the wireless interface is further configured to receive from the remote server at least one of a modified 3D model, a two-dimensional rendering, flash and animated images of the human subject based on the 3D reconstruction.

29. An apparatus comprising:
means for capturing a video frame sequence of a human subject on a mobile device while at least one of the mobile device and the human subject is moved with respect to the other;
means for displaying a pre-generated marker on a display of the mobile device while capturing the video frame sequence, wherein the human subject is displayed on the display while capturing the video frame sequence while the mobile device is held to cause the human subject to be displayed coincidently with the pre-generated marker;
means for using the video frame sequence captured while the mobile device is held to cause the human subject to be displayed coincidently with the pre-generated marker to generate a three-dimensional (3D) reconstruction of the human subject; and
means for storing the 3D reconstruction of the human subject.

30. The apparatus of claim 29, wherein the pre-generated marker is a 3D model of a humanoid object.

31. The apparatus of claim 30, further comprising means for deforming the pre-generated 3D model of the humanoid object to a shape of the human subject while capturing the video frame sequence.

32. The apparatus of claim 29, further comprising means for adjusting at least one of a position and size of the pre-generated marker in the display to be coincident with the display of the human subject based on user input.

33. The apparatus of claim 29, further comprising:
means for using sensors to determine pose information for the mobile device with respect to the human subject while capturing the video frame sequence; and
means for adjusting at least one of a position and size of the pre-generated marker in the display based on the pose information while the video frame sequence is captured.

34. The apparatus of claim 33, wherein the sensors comprise at least one of accelerometers, gyroscopes, and magnetometers.

35. The apparatus of claim 29, further comprising means for transmitting the 3D reconstruction of the human subject to a remote server.

36. A non-transitory computer-readable medium including program code stored thereon, comprising:
program code to display a pre-generated marker on a display while capturing a video frame sequence of a human subject with a camera while at least one of the camera and the human subject is moved with respect to the other and the camera is held to cause the human subject to be displayed coincidently with the pre-generated marker;
program code to use the video frame sequence captured while the camera is held to cause the human subject to be displayed coincidently with the pre-generated marker to generate a three-dimensional (3D) reconstruction of the human subject; and
program code to store the 3D reconstruction of the human subject.

37. The non-transitory computer-readable medium of claim 36, wherein the pre-generated marker is a 3D model of a humanoid object.

38. The non-transitory computer-readable medium of claim 37, further comprising program code to deform the pre-generated 3D model of the humanoid object to a shape of the human subject while capturing the video frame sequence.

39. The non-transitory computer-readable medium of claim 36, further comprising program code to adjust at least one of a position and size of the pre-generated marker in the display to be coincident with the display of the human subject based on user input.

40. The non-transitory computer-readable medium of claim 36, further comprising:
program code to determine pose information for the camera with respect to the human subject while capturing the video frame sequence based on sensor data; and
program code to adjust at least one of a position and size of the pre-generated marker in the display based on the pose information while capturing the video frame sequence.

41. The non-transitory computer-readable medium of claim 36, further comprising program code to transmit the 3D reconstruction of the human subject to a remote server.
